(19) United States
(12) Patent Application Publication
(10) Pub. No.: US 2010/0006522 A1
(43) Pub. Date: Jan. 14, 2010

(54) ANIMAL HOUSING UNIT AND RACKING SYSTEM

(76) Inventors: Richard P. Ver Hage, Midland Park, NJ (US); Glenn R. Ver Hage, Midland Park, NJ (US); Henry W. Ver Hage, Midland Park, NJ (US)

Correspondence Address: SOFER & HAROUN LLP., 317 MADISON AVENUE, SUITE 910, NEW YORK, NY, 10017, US

(21) Appl. No.: 12/497,286

(22) Filed: Jul. 2, 2009

Related U.S. Application Data
(60) Provisional application No. 61/133,837, filed on Jul. 2, 2008.

(51) Int. Cl. A01K 1/03

(52) U.S. Cl. 211/71.01

(57) ABSTRACT

An animal cage rack has a plurality of bays for receiving animal cages, where each bay has a first shelf for supporting the animal cage and a first cage mounting rail for supporting the cage in the bay in an alternative manner, where, in each manner for support, the animal cage rack provides ventilation for the animal cage in the bay.

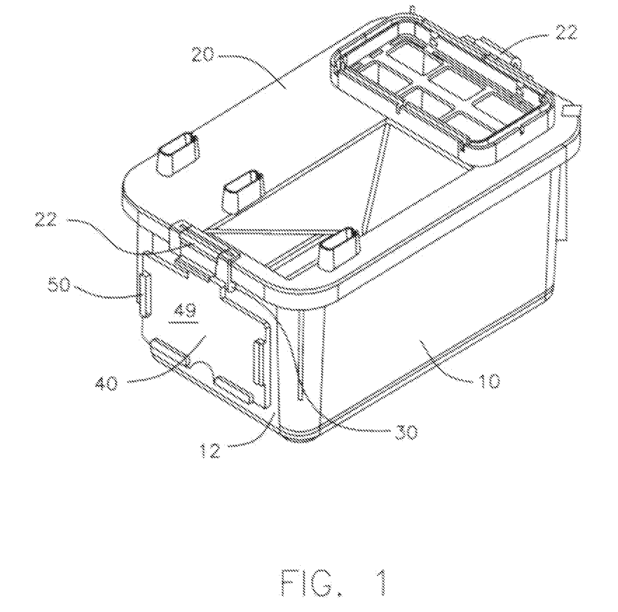

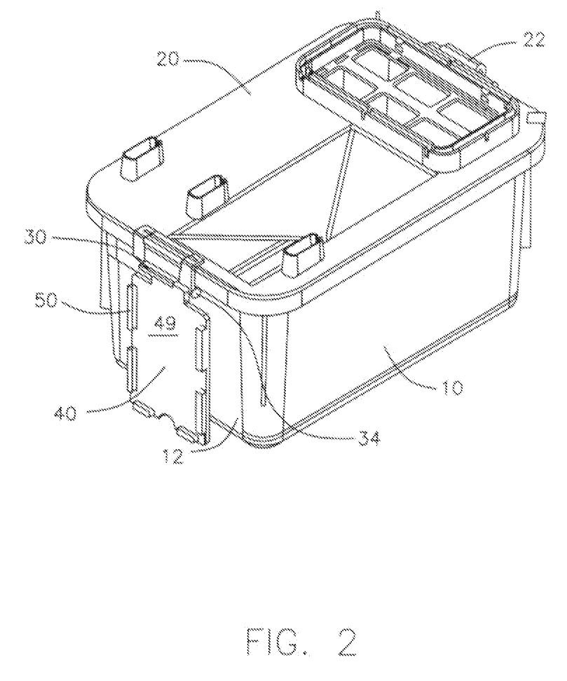

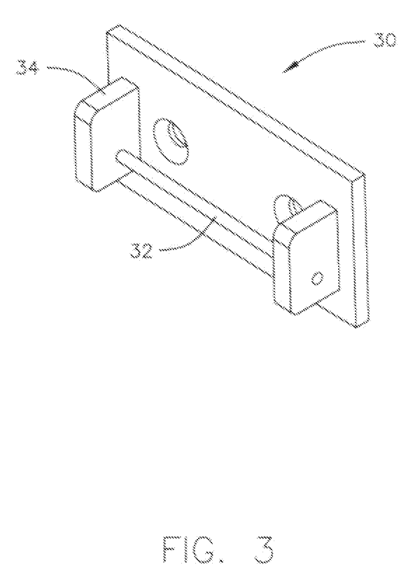

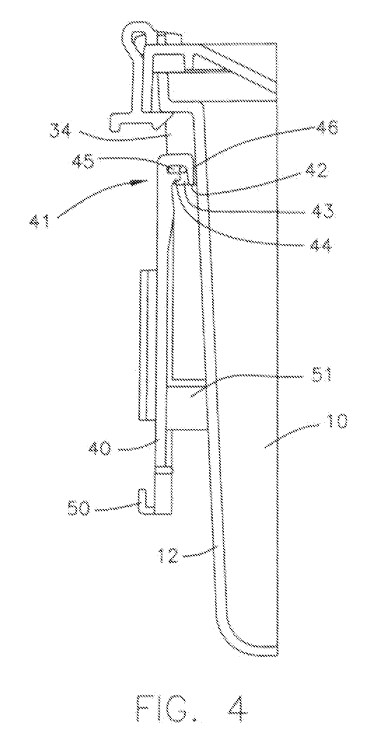

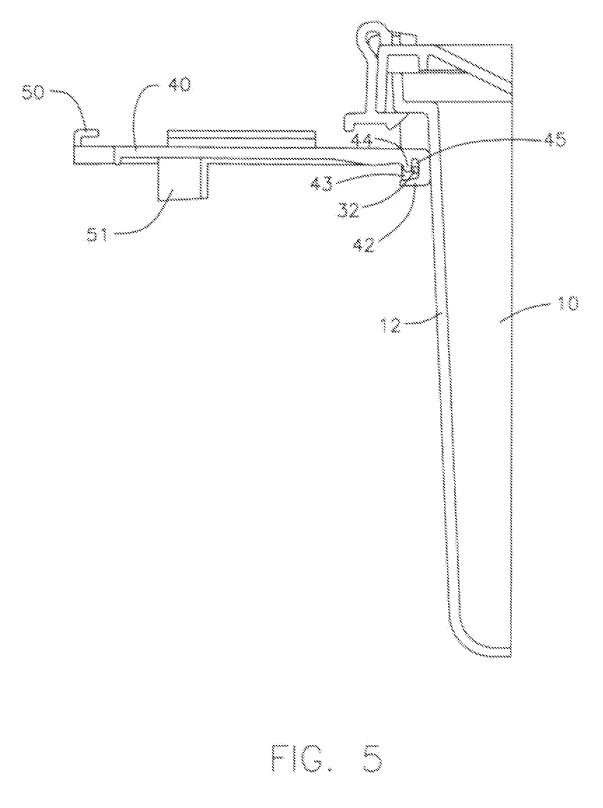

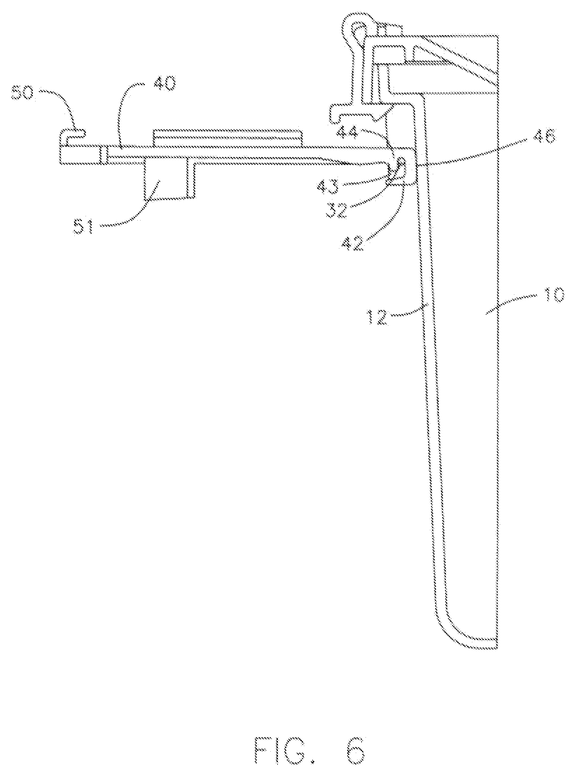

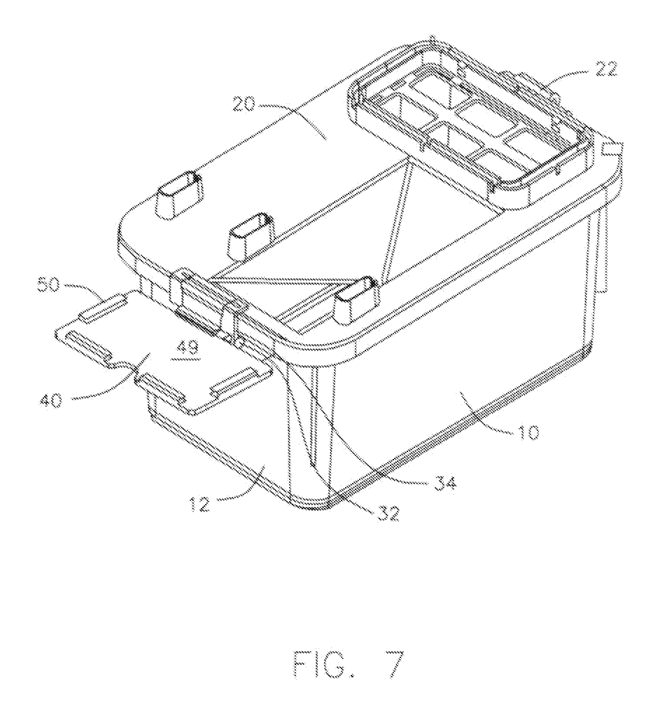

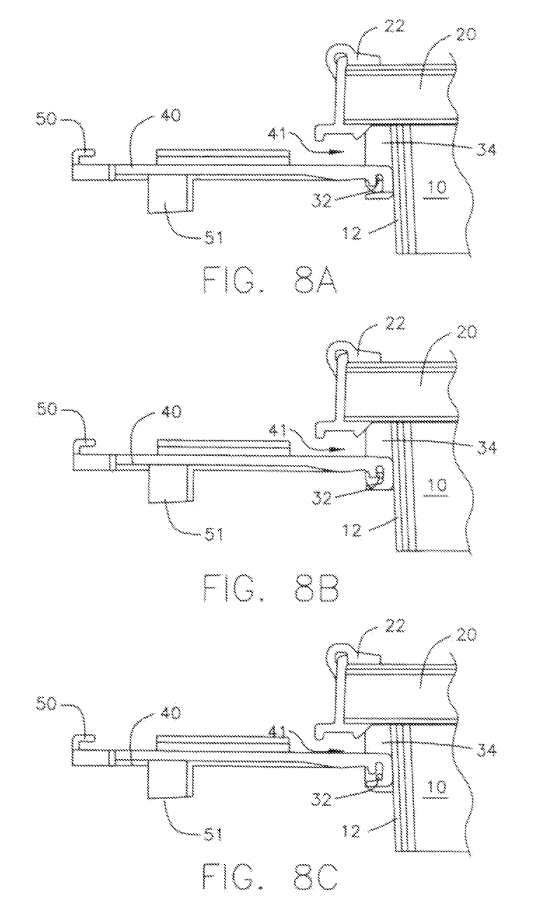

### RELATED APPLICATION

This applicat

### FIELD OF THE INVENTION

This invention relates to housing units and equipment used for housing animals.

### BACKGROUND

In the field of commercial application animal cages there are a number of existing arrangements for maintaining numerous animal cages within a single rack system. For example, larger testing projects at commercial and higher learning institutions may require upwards of hundreds of manageable habitats for maintaining the animals required. A typical arrangement may require the maintaining of several hundred lab mice, requiring a hundred or more separate cages.

As such, multi-cage rack systems have been developed for easier management of the animals. These racks typically hold about 90-150 cages for mice and 25-50 cages for larger animals. The cages are stored in the rack, but are removable for cleaning, feeding and for removing or inserting the animals

The racks usually are constructed in 3 basic styles: Basic shelf, suspended cage and ventilated cage.

Basic: An animal housing unit, complete with micro-liter top, wire bar lid, cage and water bottle are set on shelves.

Suspended: An animal housing unit or cage is suspended from the underside of a shelf. The shelf usually has a series of perforated holes through it to allow air to move in and out of the cage. The shelf usually has a filter paper over the holes to filter the air that moves in and out of the cage. There are provisions within the cage for food and provisions from within or from outside the cage for water.

Ventilated: An animal housing unit is held in a rack where clean air is forced into the individual cages providing ventilation. In many ventilated rack systems the air that comes out of the cages is collected through a suction air system and then filtered.

### SUMMARY

The present invention looks to combine the features and benefits of the suspended cage rack with those of the ventilated cage rack. The resulting rack would be a hybrid rack that could be used as either.

The present invention also looks to improve the methodology for removing or checking the animals in the individual housing unit. This is accomplished by providing a unique cage, wire bar lid and micro-filter top design.

### BRIEF DESCRIPTION OF THE DRAWING

FIG. #1 shows the hybrid rack assembly #1 with cage assemblies #20 consisting of a cage #13, a micro-filter top #12 and a wire bar lid #14 (not shown) in their individual locations.

Air plenums #6 & #7 and duct #5 are shown. They are used for the ventilation rack features.

The shelf #9, shelf perforations #2 and filter paper hold down latch #8 are shown. They are used for the suspended rack features.

FIG. #2 shows the cage assembly closed.

FIG. #3 shows the cage assembly open.

FIG. #2 & #3 show the unique way access is provided to the inside of the cage #13 area. This is done by incorporating doors #15 and #17 and latches #16 & #18 in the micro-filter top #12 and the wire bar lid #14.

FIG. #4 shows the cage latching tabs and rail design.

### DETAILED DESCRIPTIONS

1) Design That Combines the Suspended Rack and the Ventilated Rack.

In one embodiment of the present invention, the design forces clean air into cage assembly #20. The clean air is blown from a blower filter unit into the pressure plenum #7, from there the air is channeled through ducts and nozzles to the inside of the cage assembly #20. The air flows around the inside of the cage assembly and exits through the micro-filter top #19. The filter keeps much of the particular dirt inside the cage; however, the air exiting through the filter is still contaminated. From there the contaminated air is sucked into the suction duct #5 which is located above the micro-filter top #12 and has suction holes above the micro barrier top filter #19. The air then continues to the suction plenum #6 and out to the Suction Filtration System.

If forced ventilating and suction air is not being used the rack can be used as a suspended rack. When using the rack as a suspended rack: 1) Caps are put on the cylindrical flanges #34 on the top of the suction and pressure plenums #6 and #7 to seal them. 2) A rectangular filter paper #21 is placed on the top of each shelf #9. The filter paper runs from side to side and from the front flange # 22 to the suction duct #5. It is locked in place by the filter paper hold down latches # 8 located on each side. The filter paper covers the perforated holes #2 and filters the air that goes through them. 3) The cage assembly #20 is used without the micro-filter top #13 and possibly without the wire bar lid #14.

In order to use the rack as a suspended rack the cage mounting rails #23 are designed to seal the side space between the cage upper rim and the bottom of the shelf #9. In the back of the cage mounting rails #11 there is a connecting piece that goes between two mounting rails that seals the space in the back area of the cage along the top upper rim and the bottom of the shelf. In front of the cage there is a locking rail #10 which slides down and seals the space along the front edge.

The design of those three elements, the cage mounting rail #11, the connecting piece at the rear that goes between the cage mounting rails #11 and the front locking rail #10 enclose the perimeter of the top edge of the cage creating minimal space so that animals contained in the cage assembly #20 cannot fit through that space and climb out of the cage.

2) Unique Cage, Wire Bar Lid and Micro-Filter Top Design

The cage #13, micro-filter top #12 and wire bar lid #14 are designed in such a way that there is access to the inside of the cage without complete removal of the cage #13 from the rack #1 or without the removal of the micro filter top or wire bar lid.

The design currently being used requires the micro filter top #12 and the wire bar lid #14 to be removed to have access into the cage #13.

The present invention improves upon current methodology for removing and checking the animals and the inside of the cages #13 by providing a door which can be opened to gain access to the inside of the cage. This door is incorporated in both the micro filter top #12 and wire bar lid #14.

FIG. #2 and #3 show the micro filter top door #15 and wire bar lid door #17 in both the closed and open positions. Incorporated into both doors are interacting latching mechanisms #16 & #18. The interacting latching mechanisms are designed to work independently and together. The latching mechanism #18 on the wire bar door locks the door #17 closed. It is opened by either manually pushing on a tab to unlock the door #17, or by moving the latch #16 in the micro-barrier top.

The micro-barrier top door #15 is designed to work in three ways.

When the micro filter top #12 is off the cage #13 and standing alone, the micro filter top door latch #16 is designed to lock the micro-barrier door#15 closed for transportation and washing.

The micro filter top #12 is also designed to work as an assembly when the micro filter top #12 is mounted on top of the wire bar lid #14 and the two of them are assembled on top of the cage #13. When the three are assembled the micro filter top door latch #16 will work in two ways.

First, the micro filter top door latch #16 can be moved in such a way that it will just open the micro filter top door #15. Operating just the micro filter top door allows the technician to look inside the cage, check what is happening to the animals and see the condition inside of the cage while the wire bar lid door #17 stays in the locked position, so there is no need to worry about the animals trying to climb out or escaping.

The second way the micro-barrier top door latch #18 works, it unlocks both the micro filter top door #15 and the wire bar lid door #17 at the same time. When the micro filter top door latch #16 is operated in a 2^{nd} way the micro filter top latch # 16 engages the wire bar lid door latch #18^{th}. They lock together and both the micro filter top door #15 and the wire bar lid door # 17 open and close in unison. This allows for opening both doors with one hand and provides full opening #33 into the cage #13. In this open position, as shown in FIG. #3, animals can be removed, repositioned or physically checked as well as other necessary checks and procedures such as bedding and feed conditions can be checked without removing the cage assembly #20 from the rack #1 and then removing both the micro filter top #12 and wire bar lid #14 off the cage #13 as done in current designs.

Another feature built into the cage #13 is a unique hands free latching mechanism that latches the cage #13 in place on the cage mounting rails #11 in the rack #1 without using additional springs, levers or other pieces. Refer to FIG. #4. To do this, there are two tabs #36 and #37 on either side of the cage #13 rim lip #40. The tabs work in conjunction with the cage mounting rails #11. There are two tabs positioned on either side of the cage. The tabs are under the cage #13 rim lip #40. One tab #36 is towards the Technician side of the cage. When the cage is properly engaged fully pushed in, that tab drops into a groove #37 on the cage mounting rail #11 and locks the cage in place so it cannot vibrate or be accidentally moved backwards towards the technician and out of position. To move the cage out, the cage assembly #20 is picked up slightly at the front end, disengaging the locking tab #36 from the cage mounting rail #11 and then the cage is pulled back. Once the locking tab #36 clears the groove #37, the cage assembly #20 can continue to be pulled out parallel to the mounting rail #11. Mounted further down the under side of the cage rim #40 is the second tab #38 which does not engage the cage mounting rail #11 until the cage assembly #20 is pulled out roughly half way. At that point that tab #38 hits the second stop #39 on the cage mounting rail #11 and stops the cage assembly #20 from going further unless the cage assembly #20 is picked up slightly a second time. The second tab #38 at the second stop position #39 on the cage mounting rail #11 allows the cage assembly #20 to be moved out a little bit past half way and firmly locked there so it will not accidentally be moved further. In this position the micro filter top door #15 and the wire bar lid door #17 can be opened to look and work inside the cage #13 opening #33.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. An animal cage rack comprising:
a plurality of bays for receiving animal cages, wherein each bay further comprises:
a first shelf for supporting said animal cage; and
a first cage mounting rail for supporting said cage in said bay in an alternative manner, wherein in each manner for support said animal cage rack provides ventilation for said animal cage in said bay.
